(19) United States
(12) Patent Application Publication
(10) Pub. No.: US 2021/0394224 A1
(43) Pub. Date: Dec. 23, 2021

(54) GLUING DEVICE CONVENIENT FOR DETACHING AND ASSEMBLING

(71) Applicant: TRIPLE WIN TECHNOLOGY(SHENZHEN) CO.LTD., Shenzhen (CN)

(72) Inventor: YONG SUN, Shenzhen (CN)

(21) Appl. No.: 17/354,440

(22) Filed: Jun. 22, 2021

(30) Foreign Application Priority Data
Jun. 23, 2020 (CN) 202010584070.1

(51) Int. Cl. B05C 5/02

(52) U.S. Cl. CPC B05C 5/0212

(57) ABSTRACT

A gluing device includes a glue tube, a connector, a needle unit, and a locking element. One end of the connector is connected to a glue outlet of the glue tube, other end of the connector is connected to a glue inlet of the needle unit. The locking element is sleeved on a connection part of the connector and the needle unit. The needle unit is connected to the connector by the locking element and allows detachment. The glue tube, the connector, and the needle unit together form a glue channel in the gluing device. The connector and the locking element make detachment and assembly of the needle unit on the glue tube easy and simple, even though a diameter of the needle unit is very small.

### FIELD

The subject matter relates to manufacturing, and more particularly, to a gluing device convenient for detaching and assembling.

### BACKGROUND

Different components in an electronic product may require to be bonded together by glue. Since these components may be small in size, applying glue onto the component may be difficult.

A common method to apply glue installs a needle onto a glue tube, and squeezing the glue tube to force the glue out through the needle. However, a diameter of the needle is very small, causing installation difficulties with the needle where it is to be used on a complex machine platform. Furthermore, a needle is fragile and easily damaged. A better arrangement for applying the glue is needed.

### BRIEF DESCRIPTION OF THE DRAWINGS

Implementations of the present technology will now be described, by way of example only, with reference to the attached figures.

FIG. 1 is a cross-sectional view of an embodiment of a gluing device according to the present disclosure.

FIG. 2 is an enlarged view of a portion A of FIG. 1.

FIG. 3 is a diagrammatic view of a connector in the gluing device of FIG. 1.

FIG. 4 is a diagrammatic view of another connector of the gluing device of FIG. 1.

FIG. 5 is diagrammatic views showing an assembling process of another embodiment of a gluing device according to the present disclosure.

FIG. 6 is a diagrammatic view of yet another embodiment of a gluing device according to the present disclosure.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

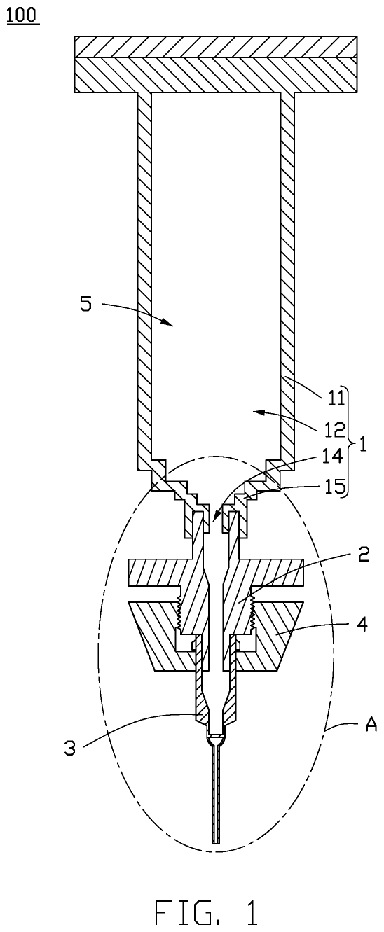

FIGS. 1 to 3 illustrate an embodiment of a gluing device (gluing device 100), which includes a glue tube 1, a connector 2, a needle unit 3, and a locking element 4. One end of the connector 2 is connected to a glue outlet of the glue tube 1, and other end of the connector 2 is connected to a glue inlet of the needle unit 3. The locking element 4 is sleeved on an interconnection region of the connector 2 and the needle unit 3. The needle unit 3 can be detachably connected to the connector 2 through the locking element 4. The glue tube 1, the connector 2, and the needle unit 3 are connected to form a glue channel 5 for receiving glue. The connector 2 and the locking element 4 make it easy and convenient to assemble the needle unit 3 to the glue tube 1, even though a diameter of the glue-passing passage of needle unit 3 may be very small.

Referring to FIG. 1, the glue tube 1 includes a tube body 11, a body cavity 12 defined in the tube body 11, a tube connecting head 15 positioned at an end of the tube body 11, and a connect cavity 14 defined in the tube connecting head 15. The connect cavity 14 and the body cavity 12 are connected to each other.

In an embodiment, the glue tube 1 may be made of plastic and rubber.

In an embodiment, the tube connecting head 15 may be made of plastic and rubber.

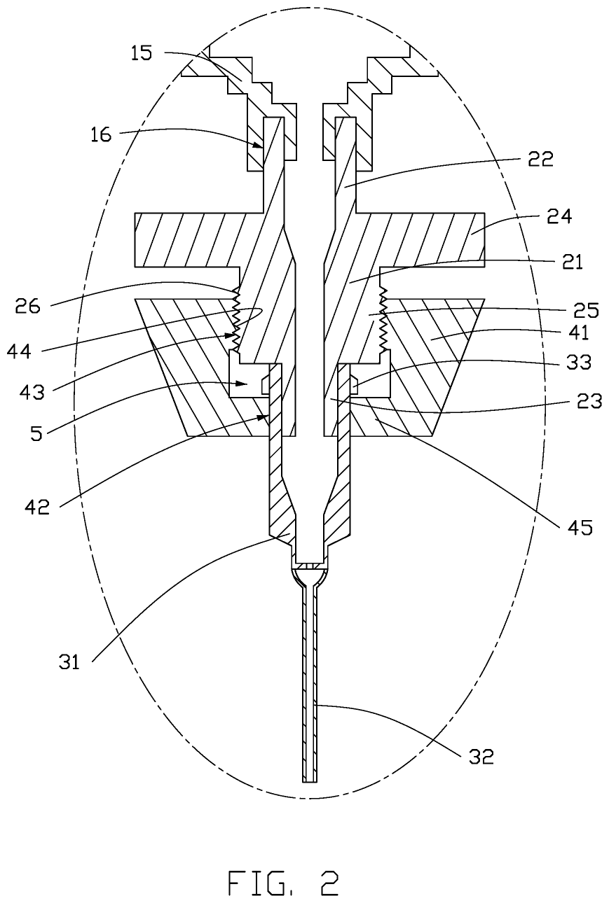

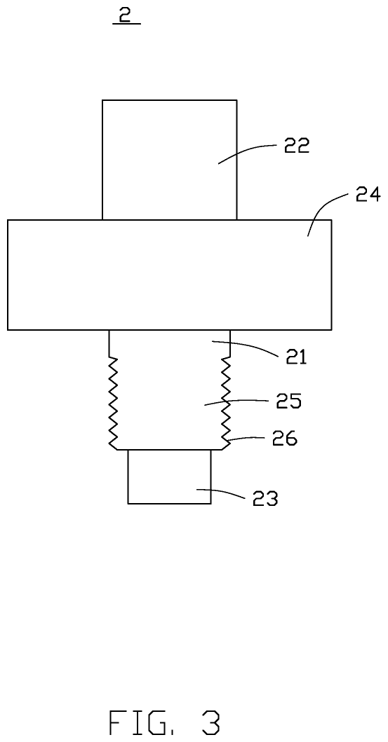

Referring to FIGS. 2 and 3, the connector 2 includes a connector body 21, a first connecting head 22, a second connecting head 23, at least one bulge part 24, and a third connecting head 25. The first connecting head 22 is positioned at an end of the connector body 21 close to the glue tube 1. The second connecting head 23 is positioned at an end of the connector body 21 close to the needle unit 3. Each bulge part 24 is between the first connecting head 22 and the second connecting head 23. The third connecting head 25 is between the second connecting head 23 and the bulge part 24. The connector 2 connects the glue tube 1 to the needle unit 3.

In an embodiment, the first connecting head 22, the second connecting head 23, and the third connecting head 25 are coaxial, and form a hollow structure when connected to each other. The hollow structure is a part of the glue channel 5.

In an embodiment, the first connecting head 22 and the tube connecting head 15 are connected by interference fit. A fixing groove 16 is defined in the tube connecting head 15. An external dimension of the first connecting head 22 slightly exceeds an internal dimension of the fixing groove 16. The first connecting head 22 can be inserted in the fixing groove 16, so as to connect to the tube connecting head 15 by interference fit.

In an embodiment, the tube connecting head 15 is made of rubber. An outer wall of the fixing groove 16 can expand when the first connecting head 22 is inserted in the fixing groove 16. An elastic restoring force of the outer wall of the fixing groove 16 retains the first connecting head 22 in the tube connecting head 15.

In an embodiment, an external dimension of the third connecting head 25 slightly exceeds an external dimension of the second connecting head 23. The needle unit 3 is sleeved on the second connecting head 23. The locking element 4 is sleeved on the third connecting head 25 and the needle unit 3, so as to connect the needle unit 3 detachably to the connector 2.

Referring to FIGS. 2 and 3, the connector 2 can be rotated when a user holds the bulge part 24. In an embodiment, the bulge part 24 is ring-shaped on the outer wall of the connector body 21.

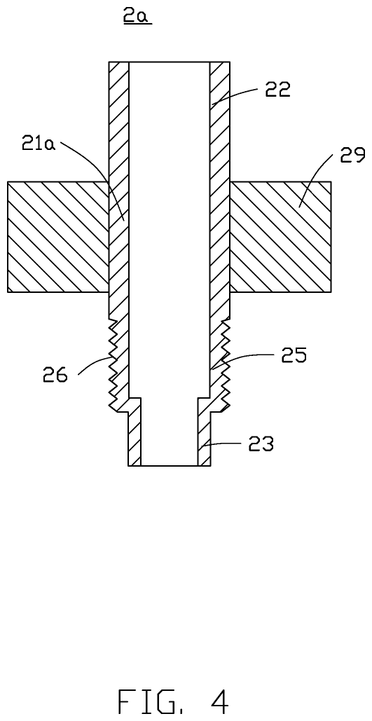

In another embodiment, referring to FIG. 4, two bulge parts 29 are included in the connector 2a. The two bulge parts 29 are positioned on two opposite surfaces of the connector body 21a.

Referring to FIGS. 2 and 3, the needle unit 3 includes a rubber head 31 and a needle 32. The rubber head 31 and the needle 32 are connected to each other. The rubber head 31 is sleeved on the second connecting head 23. The needle 32 is positioned on an end of the rubber head 31 away from the second connecting head 23.

In an embodiment, a limiting block 33 is positioned on an outer wall of the rubber head 31. The limiting block 33 allows the locking element 4 to lock the locking element 4 to the needle unit 3 when connected.

Referring to FIGS. 1 and 2, the locking element 4 includes a locking body 41, a locking sidewall 45, a first through hole 42, and a second through hole 43. The locking sidewall 45 is positioned on one end of the locking body 41. The first through hole 42 is in the locking sidewall 45, and the second through hole 43 is in the locking body 41. The first through hole 42 and the second through hole 43 are coaxial. An internal dimension of the first through hole 42 slightly exceeds an external dimension of the third connecting head 25, but is smaller than the second through hole 43. The rubber head 31 is positioned in first through hole 42. The third connecting head 25 is positioned in the second through hole 43, and is movably connected to the locking element 4. The limiting block 33 is positioned in the second through hole 43, and is engaged with the locking sidewall 45. Thereby, the locking element 4 is engaged with the needle unit 3, so that the needle unit 3 will not fall from the connector 2.

In an embodiment, the third connecting head 25 is connected to the locking element 4 by screw threads.

In an embodiment, an external thread 26 is arranged on an outer wall of the third connecting head 25. An internal thread 44 matching the external thread 26 is arranged on an inner wall of the second through hole 43. Through the engagement of the internal thread 44 and the external thread 26, the locking element 4 is fixed on the connector 2. The gluing device 100 has a simple structure, and assembly and disassembly of the needle unit 3 is more convenient.

In an embodiment, a buffer cavity 5 is formed between the locking sidewall 45 and the third connecting head 25. Since a gap is formed between the rubber head 31 and the second connecting head 23 during a gluing process, a small amount of glue is squeezed to the outside of the rubber head 31 under pressure, and then the small amount of glue flows into the buffer cavity 5. Therefore, the buffer cavity 5 prevents any glue residue from solidifying at an interconnection region of the rubber head 31 and the second connecting head 23, congealed residue would impede disassembly of the needle unit 3.

In an embodiment, the locking element 4 is a trapezoidal locking nut.

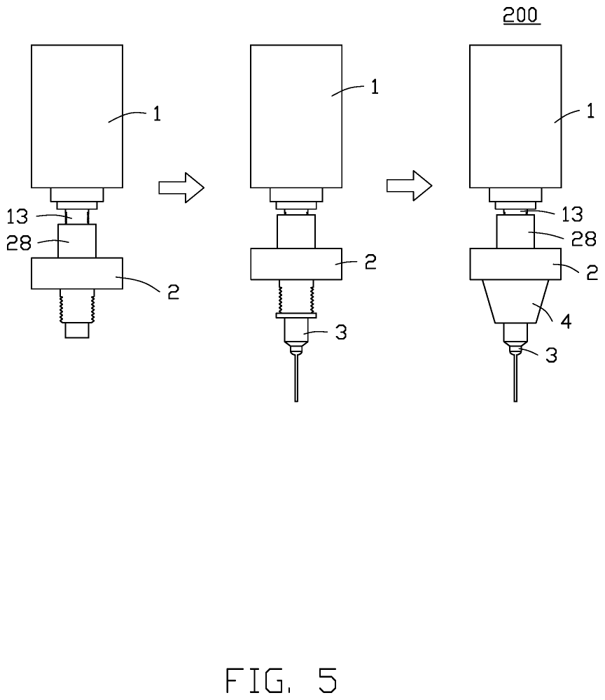

FIG. 5 illustrates another embodiment of a gluing device (gluing device 200). Gluing device 200 is different from the gluing device 100, in that the first connecting head 28 is connected to the tube connecting head 13 by screw threads. In an embodiment, another external thread (not shown) is arranged on an outer wall of the tube connecting head 13. Another internal thread (not shown) matching the external thread is arranged on an inner wall of the first connecting head 28. Through the engagement of the internal thread and the external thread, the tube connecting head 13 is fixed on the first connecting head 28.

FIG. 5 illustrates a method for assembling the gluing device 200. First, the first connecting head 28 is connected to the tube connecting head 13 by screw threads, so as to connect the needle unit 3 to the connector 2. Then, the needle unit 3 is connected to the connector 2 by interference fit. Finally, the locking element 4 is screwed on the connector 2. The connector 2 and the needle unit 3 are locked by the locking element 4.

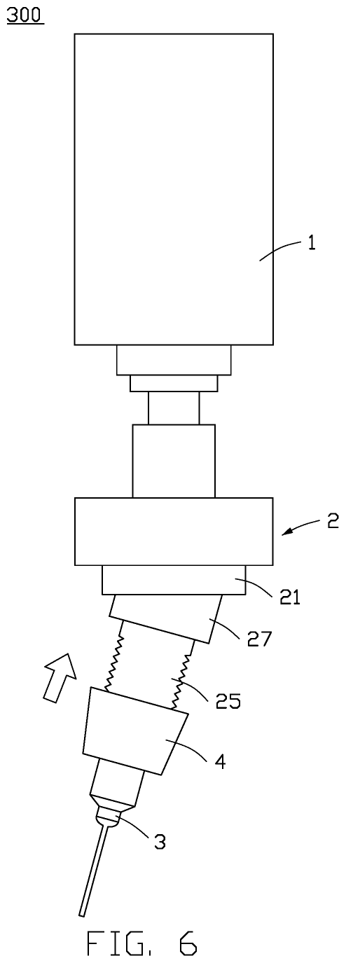

FIG. 6 illustrates a third embodiment of a gluing device (gluing device 300). Gluing device 300 is different from the gluing device 100, in that an angle adjustment block 27 is formed between the third connecting head 25 and the connector body 21. The angle adjustment block 27 defines a cavity connecting to the glue channel 5. The angle adjustment block 27 forms an acute angle “a” between the connector body 21 and the third connecting head 25. In some applications, a needle unit my need to be curved or bent for access to a work site, and to avoid damage and blocking, the angle adjustment block 27 between the third connecting head 25 and the connector body 21 allows articulation of the needle unit 3.

The gluing devices 100, 200, and 300 have the following advantages:

1. The glue tube 1 has elasticity and can connect to the connector 2 by interference fit, which prevents overflowing of the glue. Disassembly and assembly of the glue tube 1 is rendered quicker and convenient.

2. The connector 2 and the locking element 4 allow the glue tube 1 and the needle unit 3 to be independently assembled and disassembled. The glue tube 1 can be replaced with a new one when the glue is used up. The needle unit 3 can be replaced with a new one if the needle unit 3 becomes blocked by the glue.

3. The needle unit 3 is connected to the connector 2 by the locking element 4, rendering disassembly of the needle unit 3 and the glue tube 1 more convenient.

4. The angle adjustment block 27 between the third connecting head 25 and the connector body 21 allows articulation of the needle unit 3, and avoids curving or bending for access to a work site.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including, the full extent established by the broad general meaning of the terms used in the claims.

What is claimed is:

1. A gluing device, comprising:
a glue tube;
a connector;
a needle unit; and
a locking element,
wherein, one end of the connector is connected to the glue tube, and other end of the connector is connected to the needle unit, the locking element is sleeved on an interconnection region of the connector and the needle unit, the needle unit is detachable connected to the connector by the locking element, the glue tube, the connector, and the needle unit communicate with each other to form a glue channel in the gluing device.

2. The connecting article of claim 1, wherein the connector comprises:
a connector body;
a first connecting head; and
a second connecting head,
wherein the first connecting head is positioned at an end of the connector body close to the glue tube, the second connecting head is positioned at an end of the connector body close to the needle unit, the first connecting head is connected to the glue tube, and the second connecting head is connected to the needle unit.

3. The connecting article of claim 2, wherein the glue tube comprises:
a tube body;
a body cavity defined in the tube body;
a tube connecting head positioned at an end of the tube body; and
a connect cavity defined in the tube connecting head,
wherein the connect cavity and the body cavity are connected to each other, the first connecting head and the tube connecting head are connected to each other.

4. The connecting article of claim 3, wherein the first connecting head and the tube connecting head are connected to each other by screw threads.

5. The connecting article of claim 3, wherein a fixing groove is arranged in the tube connecting head, the first connecting head is inserted in the fixing groove and connects to the tube connecting head by interference fit.

6. The connecting article of claim 3, wherein an external dimension of the first connecting head exceeds an internal dimension of the fixing groove.

7. The connecting article of claim 6, wherein the tube connecting head is made of at least one of plastic and rubber.

8. The connecting article of claim 2, wherein the needle unit comprises a rubber head and a needle, the rubber head and the needle are connected to each other, the rubber head is sleeved on the second connecting head.

9. The connecting article of claim 8, wherein the locking element comprises:
a locking body,
a locking sidewall,
a first through hole; and
a second through hole,
wherein the locking sidewall is positioned on one end of the locking body, the first through hole is in the locking sidewall, and the second through hole is in the locking body, the first through hole and the second through hole are coaxial, an internal dimension of the first through hole exceeds an external dimension of the third connecting head, and is smaller than the second through hole, the rubber head is positioned in first through hole, and the third connecting head is positioned in the second through hole, and is movably connected to the locking element.

10. The connecting article of claim 8, wherein a limiting block is positioned on an outer wall of the rubber head, and the limiting block is positioned in the second through hole and engaged with the locking sidewall.

11. The connecting article of claim 8, wherein an external thread is arranged on an outer wall of the third connecting head, an internal thread matching the external thread is arranged on an inner wall of the second through hole, the locking element is fixed on the connector through an engagement of the internal thread and the external thread.

12. The connecting article of claim 8, wherein a buffer cavity is formed between the locking sidewall and the third connecting head.

13. The connecting article of claim 8, wherein an angle adjustment block is positioned between the third connecting head and the connector body, the angle adjustment block is defined a cavity connecting to the glue channel, and the angle adjustment block forms an acute angle between the connector body and the third connecting head.

14. The connecting article of claim 9, wherein an angle adjustment block is positioned between the third connecting head and the connector body, the angle adjustment block is defined a cavity connecting to the glue channel, and the angle adjustment block forms an acute angle between the connector body and the third connecting head.

15. The connecting article of claim 10, wherein an angle adjustment block is positioned between the third connecting head and the connector body, the angle adjustment block is defined a cavity connecting to the glue channel, and the angle adjustment block forms an acute angle between the connector body and the third connecting head.

16. The connecting article of claim 11, wherein an angle adjustment block is positioned between the third connecting head and the connector body, the angle adjustment block is defined a cavity connecting to the glue channel, and the angle adjustment block forms an acute angle between the connector body and the third connecting head.

17. The connecting article of claim 1, wherein at least one bulge part is arranged on the connector, each of the at least one bulge part is between the locking element and the glue tube.

18. The connecting article of claim 17, wherein the at least one bulge part is ring-shaped disposed around an outer wall of the connector.

19. The connecting article of claim 1, wherein at least two bulge parts are positioned on two opposite surfaces of the connector.
